(19) United States
(12) Patent Application Publication
(10) Pub. No.: US 2005/0077478 A1
(43) Pub. Date: Apr. 14, 2005

(54) Process for manufacturing radiation image storage panel

(75) Inventors: Yuji Isoda, Kanagawa (JP); Hiroshi Matsumoto, Kanagawa (JP)

Correspondence Address: SUGHRUE, MION, ZINN, MACPEAK & SEAS, 2100 Pennsylvania Avenue, N.W., Washington, DC, 20037-3202, US

(73) Assignee: FUJI PHOTO FILM CO., LTD.

(21) Appl. No.: 10/927,007

(22) Filed: Aug. 27, 2004

(30) Foreign Application Priority Data
Aug. 27, 2003 (JP) 2003-303469

(51) Int. Cl. H05B 33/00

(52) U.S. Cl. 250/484.4

(57) ABSTRACT

A process for manufacture of a radiation image storage panel having a stimulable europium activated cesium halide phosphor layer is performed by the step of vaporizing an evaporation source (europium activated cesium halide phosphor or materials yielding the phosphor) by heating, and the step of depositing the vaporized phosphor or materials to form the stimulable phosphor layer on a substrate in an evaporation-deposition apparatus, in which the vaporizing and depositing steps are performed at a pressure of 0.05 to 10 Pa and controlled to perform the deposition at a rate of 1.5 to 13 mg/cm²·min.

### FIELD OF THE INVENTION

The present invention relates to a process for manufacturing a radiation image storage panel employable in a radiation image recording and reproducing method utilizing a stimulable phosphor.

### BACKGROUND OF THE INVENTION

When the stimulable phosphor is exposed to radiation such as X-rays, it absorbs and stores a portion of the radiation energy. The phosphor then emits stimulated emission according to the level of the stored energy when exposed to electromagnetic wave such as visible or infrared light (i.e., stimulating light). Recently, the radiation image recording and reproducing method utilizing the stimulable phosphor has been widely employed in practice. In this method, a radiation image storage panel, which is a sheet having a stimulable phosphor layer, is used. The method comprises the steps of: exposing the storage panel to radiation having passed through an object or having radiated from an object, so that radiation image of the object is temporarily recorded in the storage panel; sequentially scanning the storage panel with a stimulating light such as a laser beam to emit a stimulated emission; and photoelectrically detecting the emitted light to obtain electric image signals. The storage panel thus processed is then subjected to a step for erasing radiation energy remaining therein, and then placed for the use in the next recording and reproducing procedure. Thus, the radiation image storage panel can be repeatedly used.

The radiation image storage panel (often referred to as stimulable phosphor sheet) has a basic structure comprising a support and an stimulable phosphor layer provided thereon. However, if the phosphor layer is self-supporting, the support may be omitted. Further, a protective layer is generally provided on a free surface (surface not facing the support) of the phosphor layer to keep the phosphor layer from chemical deterioration or physical damage.

Various kinds of phosphor layers are known and used. For example, a phosphor layer comprising a binder and a stimulable phosphor dispersed therein is generally used, and a phosphor layer comprising agglomerate of a stimulable phosphor without binder is also known. The latter layer can be formed by a gas phase-accumulation method or by a firing method. Further, still also known is a phosphor layer comprising a stimulable phosphor agglomerate impregnated with a polymer material.

Japanese Patent Provisional Publication 2001-255610 discloses a variation of the radiation image recording and reproducing method. While a stimulable phosphor of the storage panel used in the well known method plays both roles of radiation-absorbing function and energy-storable function, those two functions are separated in the disclosed method. In the method, a radiation image storage panel comprising a stimulable phosphor (which stores radiation energy) is used in combination with a phosphor screen comprising another phosphor which absorbs radiation and emits ultraviolet or visible light. The disclosed method comprises the steps of causing the radiation-absorbing phosphor of the screen (and of the storage panel) to absorb and convert radiation having passed through an object or having radiated from an object into ultraviolet or visible light; causing the stimulable phosphor of the storage panel to store the energy of the converted light as radiation image; sequentially exciting the stimulable phosphor with a stimulating light to emit stimulated light; and photoelectrically detecting the emitted light to obtain electric signals giving a visible radiation image.

The radiation image recording and reproducing method (or radiation image forming method) has various advantages as described above. Nevertheless, it is still desired that the radiation image storage panel used in the method have as high sensitivity and, at the same time, give a reproduced radiation image of high quality (in regard to sharpness and graininess).

In order to improve the sensitivity and the image quality, it is proposed that the phosphor layer of the storage panel be prepared by a gas phase-accumulation method such as vacuum vapor deposition or sputtering. The process of vacuum vapor deposition, for example, comprises the steps of: heating to vaporize an evaporation source comprising a phosphor or its starting materials (i.e., materials to yield the phosphor by reaction) by means of a resistance heater or an electron beam, and depositing and accumulating the vapor on a substrate such as a metal sheet to form a layer of the phosphor in the form of a columnar structure.

The phosphor layer formed by the gas phase-accumulation method contains no binder and consists essentially of the phosphor only, and there are gaps among the columnar structure of the phosphor. Because of the gaps, the stimulating light can stimulate the phosphor efficiently and the emitted light can be collected efficiently, too. Accordingly, a radiation image storage panel having that phosphor layer has high sensitivity. At the same time, since the gaps prevent the stimulating light from diffusing parallel to the phosphor layer, the storage panel can give a reproduced image of high sharpness.

U.S. Patent Publication No. 2001/0010831A1 discloses a deposition process for preparation of the phosphor layer. In the disclosed process, the deposition is controlled so that the formed phosphor layer may have a lower density than the phosphor itself in a solid state. The phosphor layer formed on the substrate consists of needle-like crystals. Also disclosed is that an inert gas such as Ar gas at a temperature of 0 to 100° C. is introduced in the deposition and evacuated so that the inner pressure of the apparatus may be 10 Pa or less. The publication further discloses that the deposition is controlled to give a deposition rate of >1 mg/cm²·min.

### SUMMARY OF THE INVENTION

It is an object of the present invention to provide a process for manufacturing a radiation image storage panel which has a stimulable phosphor layer excellent in columnar crystallinity.

It is another object of the invention to provide a process for preparation of a radiation image storage panel giving an image of high quality.

The applicants have studied the deposition process for preparation of a stimulable europium activated cesium halide phosphor layer of a radiation image storage panel, and finally found that a stimulable phosphor layer of a well-shaped columnar structure can be obtained when the deposition process is performed under a medium vacuum (at a pressure of approx. 0.05 to 10 Pa) by means of, for example, a resistance heater and controlled to give a vapor deposition rate in a specific range.

The present invention resides in a process for manufacture of a radiation image storage panel having a stimulable europium activated cesium halide phosphor layer, comprising the steps of vaporizing an evaporation source by heating, the evaporation source comprising the europium activated cesium halide phosphor or materials yielding the phosphor and depositing the vaporized phosphor or materials on a substrate to form the stimulable phosphor layer thereon in an evaporation-deposition apparatus, wherein the vaporizing and depositing steps are performed at a pressure of 0.05 to 10 Pa and controlled to perform the deposition at a rate of 1.5 to 13 mg/cm²·min.

According to the process of the invention, a stimulable phosphor layer which has a high sensitivity and gives a reproduced radiation image having an image quality such as sharpness can be produced.

### BRIEF DESCRIPTION OF DRAWINGS

FIG. 1 is a sectional view schematically illustrating an example of the evaporation-deposition apparatus used in the invention.

FIG. 2 is a sectional electron-micrograph of a stimulable phosphor layer of Example 1.

FIG. 3 is a sectional electron-micrograph of a stimulable phosphor layer of Example 6.

FIG. 4 is a sectional electron-micrograph of a stimulable phosphor layer of Comparison Example 1.

FIG. 5 is a sectional electron-micrograph of a stimulable phosphor layer of Comparison Example 4.

### DETAILED DESCRIPTION OF THE INVENTION

In the process of the present invention, atmospheric gas in the apparatus preferably is an inert gas, more preferably As gas. The inert gas pressure in the apparatus is preferably kept in the range of 0.05 to 10 Pa, more particularly 0.1 to 10 Pa, specifically 0.1 to 3 Pa, during the step of evaporation-deposition. The deposition rate is preferably controlled in the range of 2.0 to 10 mg/cm²·min. In the evaporation-deposition apparatus, the substrate is placed apart from the evaporation source preferably by a space in the range of 50 to 300 mm.

The stimulable phosphor preferably is a stimulable europium activated cesium halide phosphor represented by the following formula (I):
CsX.aM^{I}X′.bM^{II}X″₂.cM^{III}X″′₃:zEu (I)
in which M^{I} is at least one alkali metal selected from the group consisting of Li, Na, K, and Rb; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, ad, Tb, Dy, Ho, Er, Tm, Yb, Lu, Al, Ga and In; each of X, X′, X″ and X″′ independently is at least one halogen selected from the group consisting of F, Cl, Br and I; and a, b, c and z are numbers satisfying the conditions of 0≦a<0.5, 0≦b<0.5, 0≦c<0.5, and 0<z<1.0, respectively.

It is preferred that X is Br and z is a number satisfying the condition of 1×10⁻⁴≦z≦1×10⁻².

In the following description, the process for manufacturing a radiation image storage panel according to the invention is explained in detail, referring to a case where a resistance-heating process is adopted in the step of vaporization. The resistance-heating process is favorably employed in the vaporization-deposition process at a medium vacuum degree to give easily a deposited phosphor layer having good columnar crystallinity.

The substrate on which the vapor is deposited is that generally used as a support of the radiation image storage panel, and hence can be optionally selected from known materials conventionally used as a support of a radiation image storage panel. The substrate preferably is a sheet of quartz glass, sapphire glass; metal such as aluminum, iron, tin or chromium; or heat-resistant resin such as aramide. Particularly preferred is an aluminum plate. For improving the sensitivity or the image quality (e.g., sharpness and graininess), a conventional radiation image storage panel often has a light-reflecting layer containing a light-reflecting material such as titanium dioxide or a light-absorbing layer containing a light-absorbing material such as carbon black. These auxiliary layers can be provided in the radiation image storage panel of the invention. Further, in order to accelerate growth of the columnar crystals, a great number of very small convexes or concaves may be provided on the substrate surface on which the vapor is deposited. If an auxiliary layer such as a subbing layer (e.g., adhesive layer), a light-reflecting layer or a light-absorbing layer is formed on the deposition side surface of the substrate, the convexes or concaves may be provided on the surface of the auxiliary layer.

The stimulable phosphor preferably is a stimulable europium activated cesium halide phosphor represented by the above-mentioned formula (I).

The phosphor represented by the formula (I) may further comprise metal oxides such as aluminum oxide, silicon dioxide and zirconium oxide as additives in an amount of 0.5 mol or less based on one mol of CsX.

In the case where the vapor-deposited phosphor layer is formed by multi-vapor deposition (co-deposition), at least two evaporation sources are used. One of the sources contains a matrix material of the stimulable phosphor, and the other contains an activator material. The multi-vapor deposition is preferred because the vaporization rate of each source can be independently controlled to incorporate the activator homogeneously in the matrix even if the materials have very different melting points or vapor pressures. According to the composition of the desired phosphor, each evaporation source may consist of the matrix material or the activator material only or otherwise may be a mixture thereof with additives. Three or more sources may be used. For example, in addition to the above-mentioned sources, an evaporation source containing additives may be used.

The matrix material of the phosphor may be either the matrix compound itself or a mixture of two or more substances that react with each other to produce the matrix compound. The activator material generally is a compound containing an activating element (Eu), for example, a halide or oxide of the activating element.

The Eu-containing compound of the activator material preferably contains Eu²⁺ in a content of 70% or more by molar ratio because the desired stimulated emission (even if spontaneous emission) is emitted from the phosphor activated by Eu²⁺ although the Eu-containing compound generally contains both Eu²⁺ and Eu³⁺. The Eu-containing compound is preferably represented by EuXₘ (X: halogen) in which m is a number preferably satisfying the condition of 2.0≦m≦2.3. Ideally the value of m should be 2.0, but oxygen is liable to emigrate into the compound. The compound is, therefore, practically stable when m is approximately 2.2.

The evaporation source preferably has a water content of not more than 0.5 wt. %. For preventing the source from bumping, it is particularly important to control the water content in the above low range if the material of matrix or activator is a hygroscopic substance such as EuBr or CsBr. The materials are preferably dried by heating at 100 to 300° C. under reduced pressure. Otherwise, the materials may be heated under dry atmosphere such as nitrogen gas atmosphere to melt at a temperature above the melting point for several minutes to several hours.

The evaporation source, particularly the source containing the matrix material, may contain impurities of alkali metal (alkali metals other than ones constituting the phosphor) in a content of 10 ppm or less and impurities of alkaline earth metal (alkaline earth metals other than ones constituting the phosphor) in a content of 5 ppm or less (by weight). Such preferred evaporation source can be prepared from materials containing little impurities.

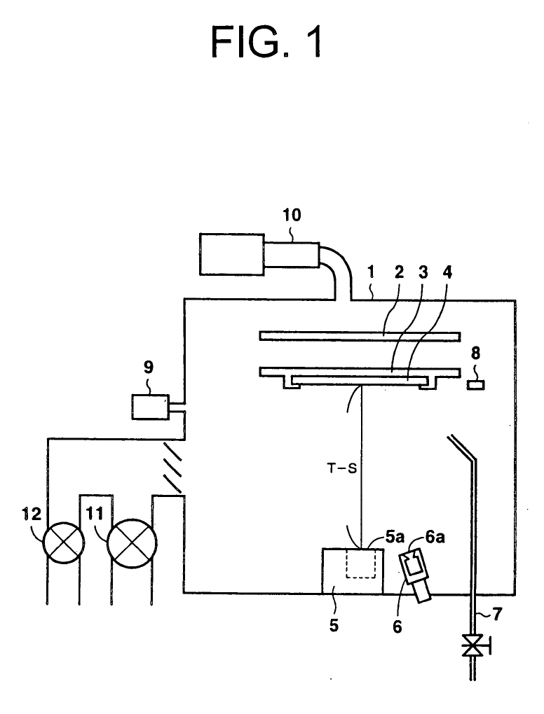

In the present invention, the phosphor layer can be formed, for example, in the evaporation-deposition apparatus shown in FIG. 1. The apparatus is equipped with resistance-heating units.

FIG. 1 is a sectional view schematically illustrating an example of the evaporation-deposition apparatus used in the invention: The apparatus shown in FIG. 1 comprises a chamber 1, a substrate heater 2, a substrate holder 3, resistance-heating units 5 and 6, an intake pipe 7, a deposition rate monitor 8, a vacuum gauge 9, a gas analyzer 10, a main exhaust valve 11, and an auxiliary exhaust valve 12.

In the apparatus shown in FIG. 1, two or more evaporation sources 5a, 6a are placed at predetermined positions on a resistance-heating units 5 and 6. The substrate 4 is mounted on a substrate holder 3. A chamber 1 is then evacuated through a main exhaust valve 11 and an auxiliary exhaust valve 12, to make the inner pressure in the range of 0.05 to 10 Pa (medium vacuum). Preferably after the chamber 1 is further evacuated to make the inner pressure in the range of 1×10⁻⁵ to 1×10⁻² Pa (high vacuum), an inert gas such as Ar, Ne or N₂ gas is introduced through an intake pipe 7 so that the inner pressure would be in the range of 0.95 to 10 Pa. In this manner, partial pressures of water and oxygen can be reduced. The degree of vacuum in the chamber 1 is monitored by means of a vacuum gauge 9, and the partial pressures of gases are monitored by means of a gas analyzer 10. The chamber 1 can be evacuated by means of an optional combination of, for example, a rotary pump, a turbo molecular pump, a cryo pump, a diffusion pump and a mechanical buster.

The space (T-S) between the substrate 4 and each of the evaporation sources 5a, 6a preferably is in the range of 50 to 300 mm.

For heating the evaporation sources 5a and 6a, electric currents are then supplied to heating units 5, 6. The sources of matrix and activator materials are thus heated, vaporized, and reacted with each other to form the phosphor, which is deposited on the substrate 4. In this step, the substrate 4 may be heated or cooled from the back side. The temperature of the substrate generally is in the range of 20 to 350° C., preferably in the range of 100 to 300° C. The deposition rate, which means how fast the formed phosphor is deposited and accumulated on the substrate, can be controlled by adjusting the electric currents supplied to the heating units 5, 6. The deposition rate of each vaporized phosphor component can be detected with a monitor 8 at any time during the deposition.

The deposition rate should be in the range of 1.5 to 13 mg/cm²·min., preferably 2.0 to 10 mg/cm²·min., more preferably 2.0 to 7.0 mg/cm²·min. If the deposition rate is lower than 1.5 mg/cm²·min., such as 1.0 mg/cm²·min., the vaporized phosphor material collide with other gaseous molecules such as inert gas molecules too frequently, and hence the desired well shaped columnar crystalline structure cannot be produced. Accordingly, the produced stimulable phosphor layer lowers in its ability to absorb the applied radiation (e.g., X-rays) and the light emission given off in the bottom portion of the phosphor layer cannot be efficiently come out of the phosphor layer.

The heating with resistance-heating units may be repeated twice or more to form two or more phosphor layers. After the deposition procedure is complete, the deposited layer may be subjected to heating treatment (annealing treatment), which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas.

Before preparing the above deposited film (layer) of stimulable phosphor, another deposited film (layer) consisting of the phosphor matrix alone may be beforehand formed. The layer of the phosphor matrix alone generally comprises agglomerate of columnar or spherical crystals, and the phosphor layer formed thereon is well crystallized in the form of columnar shape. The matrix alone-deposited layer also serves as a light-reflecting layer, and increase the amount of emission given off from the surface of the phosphor layer. In addition, if the matrix layer has a relative density in the range of 80 to 98%, it further serves as a stress-relaxing layer to enhance the adhesion between the support and the phosphor layer. In thus formed layers, the additives such as the activator contained in the phosphor-deposited layer are often diffused into the matrix alone-deposited layer while they are heated during the deposition and/or during the heating treatment performed after the deposition, and consequently the interface between the layers is not always clear.

In the case where the phosphor layer is produced by mono-vapor deposition, only one evaporation source containing the above stimulable phosphor or a mixture of materials thereof is heated with a single resistance-heating unit. The evaporation source is beforehand prepared so that it may contain the activator in a desired amount. Otherwise, in consideration of the gap of vapor pressure between the matrix components and the activator, the deposition procedure may be carried out while the matrix components are being supplied to the evaporation source.

Thus produced phosphor layer consists essentially of a stimulable phosphor in the form of columnar crystals grown almost in the thickness direction. The phosphor layer contains no binder and consists of the stimulable phosphor only, and there are gaps among the columnar crystals. The thickness of the phosphor layer depends on, for example, the desired characters of the storage panel, conditions and process of the deposition, but generally is in the range of 50 μm to 1 mm, preferably in the range of 200 to 700 μm.

The apparatus employable in the invention is not restricted to that shown in FIG. 1, and the gas phase-accumulation method usable in the invention is not restricted to the above-described resistance heating process, and various other known processes can be used as long as the deposition is carried out under a medium vacuum.

It is not necessary that the substrate is a support of the radiation image storage panel. For example, after formed on the substrate, the deposited phosphor film is peeled from the substrate and then laminated on a support with an adhesive to prepare the phosphor layer. Otherwise, the support (substrate) may be omitted.

It is preferred to provide a protective layer on the surface of the phosphor layer, so as to ensure good handling of the storage panel in transportation and to avoid deterioration. The protective layer preferably is transparent so as not to prevent the stimulating light from coming in or not to prevent the emission from coming out. Further, for protecting the storage panel from chemical deterioration and physical damage, the protective layer preferably is chemically stable, physically strong, and of high moisture proof.

The protective layer can be provided by coating the stimulable phosphor layer with a solution in which an organic polymer such as cellulose derivative, polymethyl methacrylate or fluororesin soluble in an organic solvent is dissolved in a solvent, by placing a beforehand prepared sheet for the protective layer (e.g., a film of organic polymer such as polyethylene terephthalate, or a transparent glass plate) on the phosphor layer with an adhesive, or by depositing vapor of inorganic compounds on the phosphor layer. Various additives may be dispersed in the protective layer. Examples of the additives include light-scattering fine particles (e.g., particles of magnesium oxide, zinc oxide, titanium dioxide and alumina), a slipping agent (e.g., powders of perfluoroolefin resin and silicone resin) and a crosslinking agent (e.g., polyisocyanate). The thickness of the protective layer generally is in the range of about 0.1 to 20 μm if the layer is made of polymer material or in the range of about 100 to 1,000 μm if the protective layer is made of inorganic material such as glass.

For enhancing the resistance to stain, a fluororesin layer may be further provided on the protective layer. The fluororesin layer can be formed by coating the surface of the protective layer with a solution in which a fluororesin is dissolved (or dispersed) in an organic solvent, and drying the applied solution. The fluororesin may be used singly, but a mixture of the fluororesin and a film-forming resin is generally employed. In the mixture, an oligomer having a polysiloxane structure or a perfluoroalkyl group can be further added. In the fluororesin layer, fine particle filler may be incorporated to reduce blotches caused by interference and to improve the quality of the resultant image. The thickness of the fluororesin layer generally is in the range of 0.5 to 20 μm. For forming the fluororesin layer, additives such as a crosslinking agent, a film-hardening agent and an anti-yellowing agent can be used. In particular, the crosslinking agent is advantageously employed to improve durability of the fluororesin layer.

Thus, a radiation image storage panel of the invention can be produced. The radiation image storage panel of the invention may have various structures. For example, in order to improve the sharpness of the resultant image, at least one of the films (layers) may be colored with a colorant which does not absorb the stimulated emission but the stimulating ray.

### EXAMPLE 1

(1) Evaporation Source

As the evaporation sources, powdery cesium bromide (CsBr, purity: 4N or more) and powdery europium bromide (EuBrₘ, m is approx. 2.2, purity: 3N or more) were prepared. Each of them was analyzed according to ICP-MS method (Inductively Coupled Plasma Mass Spectrometry), to find contents of impurities. It was found that the CsBr powder contained each of the alkali metals (Li, Na, K, Rb) other than Cs in an amount of 10 ppm or less and other elements such as alkaline earth metals (Mg, Ca, Sr, Ba) in amounts of 2 ppm or less. The EuBrₘ powder contained each of the rare earth elements other than Eu in an amount of 20 ppm or less and other elements in amounts of 10 ppm or less. The powders are very hygroscopic, and hence were stored in a desiccator keeping a dry condition whose dew point was −20° C. or below. Immediately before used, they were taken out of the desiccator.

(2) Preparation of Phosphor Layer

A synthetic quartz substrate as a support was washed successively with an aqueous alkaline solution, purified water and IPA (isopropyl alcohol). Thus treated substrate 4 was mounted to the substrate holder 3 in the evaporation-deposition apparatus shown in FIG. 1. The CsBr and EuBrₘ evaporation sources 5a, 6a were individually placed in crucibles of the resistance-heating units 5 and 6, respectively. The space (T-S) between the substrate 4 and each of the sources 5a, 6a was set at 150 mm. The chamber 1 of the apparatus was then evacuated through the main exhaust valve 11 and the auxiliary exhaust valve 12, to make the inner pressure 1×10⁻³ Pa by means a combination of a rotary pump, a mechanical booster and a turbo molecular pump, and successively Ar gas (purity: 5N) was introduced through the intake pipe 7 to set the inner pressure at 1.2 Pa. The substrate 4 was then heated to 100° C. by means of the substrate heater 2. Each evaporation source 5a, 6a was also heated, so that CsBr:Eu stimulable phosphor was accumulated on the surface of the substrate 4 at a deposition rate of 2.0 mg/cm²·min. During the deposition, the electric currents supplied to the heating units 5, 6 were controlled so that the molar ratio of Eu/Cs in the stimulable phosphor would be 0.003/1. Each source was first covered with a shutter (not shown), which was opened later to start the evaporation of CsBr or EuBr. After the evaporation-deposition was complete, the inner pressure of the chamber 1 was returned to atmospheric pressure and then the substrate 4 was taken out of the apparatus. On the substrate, a deposited layer (thickness: 300 μm, area: 10 cm×10 cm) consisting of columnar phosphor crystals aligned densely and almost perpendicularly was formed. Thus, a radiation image storage panel of the invention comprising a support and a phosphor layer was produced by multi-vapor deposition.

### EXAMPLES 2 to 8

The procedures of Example 1 were repeated except that the deposition rate was varied as set forth in Table 1, to manufacture a radiation image storage panel of the invention.

### COMPARISON EXAMPLES 1 TO 4

The procedures of Example 1 were repeated except that the deposition rate was varied as set forth in Table 1, to manufacture a radiation image storage panel for comparison.

[Evaluation of Radiation Image Storage Panel]

(1) Sensitivity

The radiation image storage panel was encased in a room light-shielding cassette and then exposed to X-rays (voltage: 80 kVp, current: 16 mA). The storage panel was then taken out of the cassette and excited with a He—Ne laser beam (wavelength: 633 nm), and the emitted stimulated emission was detected by a photomultiplier. The detected stimulated emission intensity was adjusted in consideration of the layer thickness to determine a stimulated emission intensity per unit thickness. On the basis of the determined stimulated emission intensity (converted into a relative value based on the intensity of Comparison Example 1), the sensitivity was evaluated.

(2) Columnar Crystallinity

The phosphor layer was perpendicularly cut together with the support and covered with a gold thin film formed by means of ion-sputtering so as to prevent the layer from electrification. The surface and the section of the thus-treated phosphor layer were observed with a scanning electron microscope to examine the shape of columnar crystals and gaps among them. The columnar crystallinity was evaluated on the following basis:
point 1.0 (worst): given to the worst crystalline condition of the phosphor layer of Comparison Example 1; and
point 10.0 (best): given to the best crystalline condition of the phosphor layer of Example 3.

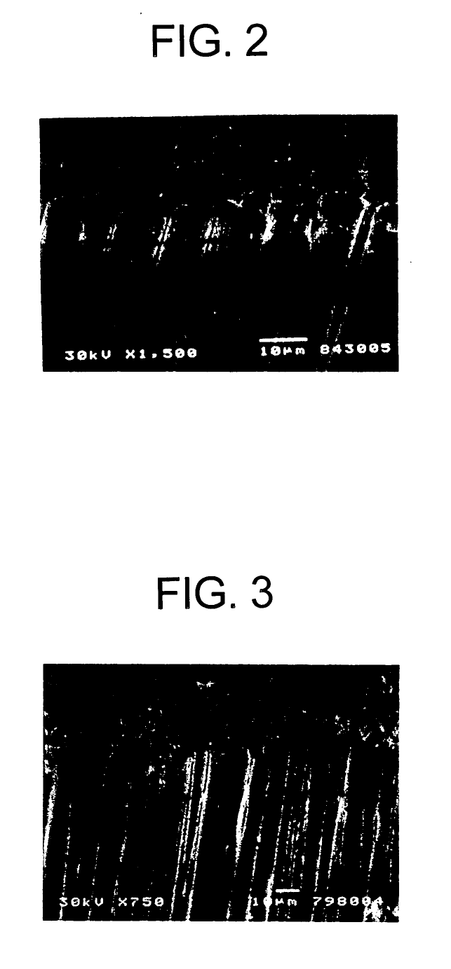

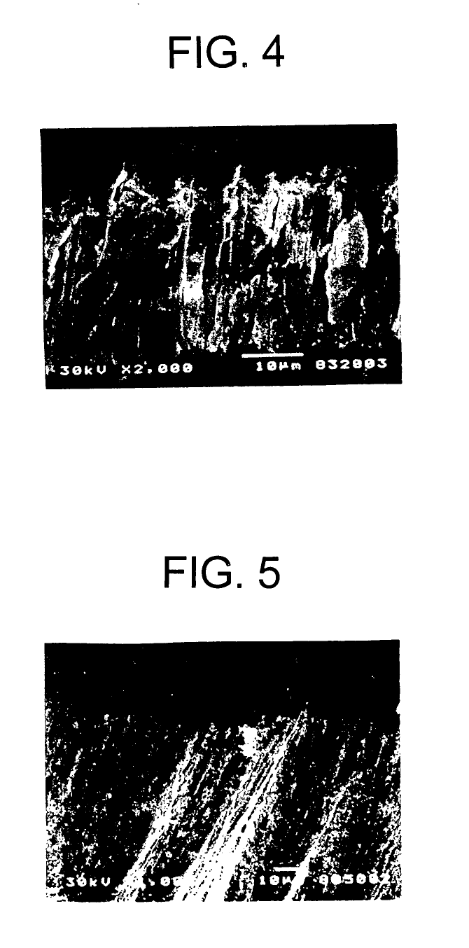

The results are illustrated in FIGS. 2 to 5 and set forth in Table 2.

TABLE 1

| | Deposition | | Conditions of |
|---|---|---|---|
| | rate | | of columnar |
| Ex. | (mg/cm² · min.) | Sensitivity | structure |
| Ex. 1 | 2.0 | 980 | 6.4 |
| Ex. 2 | 4.5 | 1674 | 9.2 |
| Ex. 3 | 5.7 | 1200 | 10.0 |
| Ex. 4 | 7.7 | 1163 | 9.6 |
| Ex. 5 | 8.3 | 993 | 9.4 |
| Ex. 6 | 9.7 | 782 | 9.2 |
| Ex. 7 | 11.3 | 616 | 5.8 |
| Ex. 8 | 1.5 | 730 | 5.0 |
| Com. 1 | 1.0 | 100 | 1.0 |
| Com. 2 | 1.4 | 650 | 1.4 |
| Com. 3 | 13.8 | 91 | 1.4 |
| Com. 4 | 14.7 | 85 | 1.2 |

The results show in Table 1 indicate that the radiation image storage panel whose phosphor layer was produced at a deposition rate of 1.5 to 13 mg/cm²·min., according to the invention (Examples 1 to 8) show sensitivity and conditions of columnar structure prominently better than those of the radiation image storage panel whose phosphor layer was produced at a deposition rate of 1.0 mg/cm²·min. (Comparison Example 1). When the phosphor layer was produced at a deposition rate higher than 13 mg/cm²·min. (Comparison Examples 3 and 4), the resulting phosphor layer shows apparently worse sensitivity and conditions of columnar structure. When the phosphor layer was produced at a deposition rate 1.4 mg/cm²·min. (Comparison Example 2), the resulting phosphor layer showed high sensitivity but the conditions of columnar structure were bad.

1. A process for manufacture of a radiation image storage panel having a stimulable europium activated cesium halide phosphor layer, comprising the steps of vaporizing an evaporation source by heating, the evaporation source comprising the europium activated cesium halide phosphor or materials yielding the phosphor and depositing the vaporized phosphor or materials on a substrate to form the stimulable phosphor layer thereon in an evaporation-deposition apparatus, wherein the vaporizing and depositing steps are performed at a pressure of 0.05 to 10 Pa and controlled to perform the deposition at a rate of 1.5 to 13 mg/cm²·min.

2. The process of claim 1, wherein the vaporizing and depositing steps are performed in an inert gas atmosphere.

3. The process of claim 2, wherein the inert gas is Ar gas.

4. The process of claim 1, wherein the steps are performed at a pressure of 0.1 to 10 Pa.

5. The process of claim 1, wherein the vaporizing and depositing steps are performed at a pressure of 0.1 to 3 Pa.

6. The process of claim 1, wherein the deposition is performed at a rate of 2.0 to 10 mg/cm²·min.

7. The process of claim 1, wherein the vaporizing and depositing steps are performed under the condition that the substrate is placed apart from the evaporation source by a space in the range of 50 to 300 mm.

8. The process of claim 1, wherein the stimulable europium activated cesium halide phosphor is represented by the formula:
CsX.aM^{I}X′.bM^{II}X″₂.cM^{III}X″′₃:zEu
in which M^{I} is at least one alkali metal selected from the group consisting of Li, Na, K, and Rb; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; each of X, X′, X″ and X″′ independently is at least one halogen selected from the group consisting of F, Cl, Br and I; and a, b, c and z are numbers satisfying the conditions of 0≦a<0.5, 0≦b<0.5, 0≦c<0.5, and 0<z<1.0, respectively.

9. The process of claim 8, wherein X is Br, and z is a number satisfying the condition of 1×10⁻⁴≦z≦1×10⁻².
